(19) United States
(12) Patent Application Publication
(10) Pub. No.: US 2014/0007846 A1
(43) Pub. Date: Jan. 9, 2014

(54) METHOD FOR CONTROLLING CATALYTIC CONVERTER HEATING MEASURES IN AN INTERNAL COMBUSTION ENGINE HAVING TWO INJECTORS PER CYLINDER

(71) Applicants: Andreas Gutscher, Markgroeningen (DE); Andreas Posselt, Muehlacker (DE); Marko Lorenz, Grossbottwar (DE)

(72) Inventors: Andreas Gutscher, Markgroeningen (DE); Andreas Posselt, Muehlacker (DE); Marko Lorenz, Grossbottwar (DE)

(21) Appl. No.: 13/976,159

(22) PCT Filed: Nov. 9, 2011
(86) PCT No.: PCT/EP11/69706

§ 371 Date: Sep. 23, 2013

(30) Foreign Application Priority Data
Dec. 27, 2010 (DE) 102010064175.8

(51) Int. Cl. F02M 69/00

(52) U.S. Cl. CPC F02M 69/00
USPC 123/472

(57) ABSTRACT

An injection system for an internal combustion engine having at least one combustion chamber is provided, the wall of the combustion chamber having a first inlet port, which is closable by a first inlet valve, and a second inlet port, which is closable by a second inlet valve, the injection system including a first injector for metered injection of fuel into the area of the first inlet port, a second injector for metered injection of fuel into the area of the second inlet port, a catalytic converter unit, and a heating device for rapidly heating the catalytic converter unit.

### BACKGROUND OF THE INVENTION

1. Field of the Invention

The present invention relates to an injection system and a method for operating an injection system.

2. Description of the Related Art

Internal combustion engines having an intake manifold injection system including two injectors per cylinder are generally known. For example, an internal combustion engine having at least one combustion chamber is known from publication published German patent application document DE 10 2008 044 244 A1, the combustion chamber having two fuel inlet ports, each of which are closable by an inlet valve. The internal combustion engine furthermore has a fuel injection device which is assigned to the at least one combustion chamber and has a first and a separate second injector for metered fuel injection into at least one intake channel of the combustion chamber. The injectors inject the fuel in the direction of the inlet valves atomized in the form of spray cones.

It is known to use catalytic converter units to comply with the emission standards of internal combustion engines. Such catalytic converter units then work efficiently in the sense of a reduction of exhaust gas emissions when they have an operating temperature of several hundred degrees Celsius. In particular, during the start phase or cold start phase of the internal combustion engine, it is therefore necessary to heat the catalytic converter unit to the operating temperature within the shortest possible period of time.

### BRIEF SUMMARY OF THE INVENTION

The injection system according to the present invention, the internal combustion engine according to the present invention, and the method according to the present invention for operating an injection system have the advantage over the related art that the internal combustion engine may be better controlled in a simple manner in such a way that it is possible to heat the catalytic converter unit more rapidly to the operating temperature. By using a heating device for heating the catalytic converter unit more rapidly in conjunction with the use of a first injector and a second injector per combustion chamber, it is particularly advantageously possible according to the present invention to reduce the time needed to heat the catalytic converter unit and thus to increase the efficiency of the catalytic converter unit. In this way, the exhaust gas emissions, in particular during the start phase or the cold start phase of the internal combustion engine, may be considerably reduced in some cases.

By using the heating device in conjunction with the use of a first and a second injector per combustion chamber, it is particularly advantageously possible according to the present invention to reduce the time needed for heating the catalytic converter unit, by injecting with the aid of the first and the second injectors a comparably large fuel quantity (in relation to the air quantity taken in) into the intake manifold (slightly rich to very rich fuel/air mixture, thus resulting in portions of uncombusted fuel, whose combustion allows a more rapid temperature increase of the catalytic converter unit, still being present in the combustion exhaust gases), by furthermore implementing a shifted ignition timing in the sense of a later ignition timing compared to a continuous operating mode of the internal combustion engine, and, in addition, by activating the heating device. By using the first injector and the second injector, the fuel metering may take place more precisely, may be reproducible more precisely, and may thus better meet the demand overall, in particular in view of the start phase or the cold start phase of the internal combustion engine. In this way, it is particularly advantageously possible according to the present invention that the droplet size of the fuel spray may be reduced, and thus defects during the combustion process may be prevented, so that a later ignition timing is possible at all. In this way, a more rapid heating of the catalytic converter unit is possible so that the time of the start and the warm-up phases is reduced as optimally as possible, and the catalytic converter unit converts as rapidly and as completely as possible. The improved combustion of the fuel mixture in the combustion chamber furthermore leads to an increased temperature in the combustion chamber and thus also to hotter untreated exhaust gases. In this way, the catalytic converter heats up more rapidly during the start and the warm-up phases (accordingly, the so-called “light-off temperature” of the catalytic converter, i.e., the temperature at which the efficiency of the catalytic converter abruptly increases, and the end of the dew point for the lambda sensor are reached more rapidly) and it reaches the light-off temperature more rapidly, starting from which the catalytic converter works efficiently. In this way, exhaust gas reductions are achievable which require a plurality of measures and are not achievable solely by individual measures. The combustion is furthermore facilitated by the use of two separate injectors, since each injector only needs a reduced through flow quantity of fuel to be injected, whereby a lower spray density is achieved, i.e., the characteristic droplet size, in particular the Sauter diameter, of the atomized fuel is advantageously reduced. The combustion behavior in the combustion chamber is significantly improved overall and fewer untreated exhaust gases are expelled due to the possibility of a finer and more precise fuel metering. Advantageously, the catalytic converter may have smaller dimensions due to the reduction of untreated exhaust gases and a portion of the noble metals required for the catalytic converter may be saved. The improved combustion and the better running smoothness achieved thereby additionally enable a lower idling speed which, in turn, reduces the exhaust gas emissions. The internal combustion engine according to the present invention preferably includes a gasoline engine having an intake manifold injection system for a motor vehicle, preferably an automobile. Here, the fuel used may be gasoline or also ethanol, or a mixture. The internal combustion engine preferably includes more than one cylinder, each cylinder including a combustion chamber having two inlet valves, one separate injector being preferably assigned to each inlet valve.

According to the present invention, it is advantageously possible by using the first and the second injectors that the desirable injection quantity of fuel may be injected with great accuracy over a wide range (of different injection quantities of fuel). For example, the first injector could have double the size of the second injector with regard to the capacity (under predefined operating conditions) of maximally injectable fuel (so-called quantity Qₛₜₐₜ); in this case, it is, for example, possible to use only the second injector (i.e., to turn off or not activate the first injector) in the case of comparably small fuel quantities to be injected and to be able to meter precisely due to the smaller capacity; in the case of medium-sized fuel quantities to be injected, it is possible to use only the first injector (i.e., to turn off or not activate the second injector) and to be able to meter precisely due to the capacity of the first injector and within a time period which is not all too long; and in the case of comparably large fuel quantities to be injected (e.g., in the case of a full load), it is possible to use both the first and the second injectors. As an alternative to dividing the total injection quantity of fuel with the aid of two differently dimensioned injectors, it is also possible to use identically dimensioned (i.e. two identical) injectors. In this way, the capacity for each injector is halved. Regardless of how the total injection quantity is divided to two injectors, it is possible according to the present invention to reduce the characteristic variable SMD (Sauter mean diameter) of the typical droplet diameter due to the reduced spray density of smaller injectors (or injectors having a smaller capacity Qₛₜₐₜ), so that a more uniform mixture formation and a later ignition timing are possible.

It is particularly preferable according to the present invention when the heating device includes a secondary air pump. It is particularly preferred here that the secondary air pump is configured to deliver fresh air into the combustion air of the internal combustion engine. In this way, it is advantageous according to the present invention that approved principles may be resorted to for the provision of additional combustion air to rapidly increase the temperature of the catalytic converter unit.

According to one preferred specific embodiment, it is provided that the first injector is situated in a first intake channel, which empties into the combustion chamber via the first intake opening, and that the second injector is situated in a second intake channel, which empties into the combustion chamber via the second intake opening. Therefore, the spray cone of each injector may be advantageously easily adapted to the particular intake channel, as well as the particular inlet port, so that, on the one hand, a wetting of the external walls of the intake channels and, on the other hand, a wetting of a separator between the first and the second inlet ports may be effectively prevented. The wall film thickness and the inhomogeneity of the mixture distribution are reduced thereby.

According to one preferred specific embodiment, it is provided that the first and the second injectors each have only one single injection opening. The first and the second injectors thus preferably each include an injection nozzle having a one-jet characteristic. In contrast to using one single injector having two injection openings (two-jet characteristic), this has the advantage that the fuel spray is adaptable more optimally to the geometry of the intake channels.

Another subject matter of the present invention is a method for operating an injection system according to the present invention. According to the present invention, it is, in particular, provided that in the situation of a start operating mode a shift of the ignition timing takes place in such a way that a later ignition timing of the fuel/air mixture in the combustion chamber is used compared to a continuous operating mode. Furthermore, it is provided according to one preferred specific embodiment that in the situation of the start operating mode, a larger fuel quantity is injected compared to a comparable operating situation of the continuous operating mode and the heating device is activated. According to the present invention, a more rapid heating time of the catalytic converter is thus advantageously achieved.

Furthermore, it is preferred that the shift of the ignition timing takes place at a temperature of the catalytic converter unit which is below a predefined limiting temperature. In this way, it is advantageously possible according to the present invention that a particularly rapid heating of the catalytic converter unit is implementable and in the presence of the necessary operating temperature of the catalytic converter unit an additional heating may be avoided, whereby fuel and energy may also be saved by avoiding injection of an additional fuel quantity (provided for heating the catalytic converter unit) and by avoiding activation of the heating device.

Exemplary embodiments of the present invention are illustrated in the drawings and explained in greater detail in the description below.

### BRIEF DESCRIPTION OF THE DRAWINGS

FIG. 1 shows a schematic top view of a cylinder head area of a cylinder of an internal combustion engine having an injection system of the present invention.

FIG. 2 shows a schematic illustration of a heating device for an injection system according to the present invention of an internal combustion engine.

### DETAILED DESCRIPTION OF THE INVENTION

In the different figures, identical parts are always provided with identical reference numerals and are thus each named or mentioned only once as a rule.

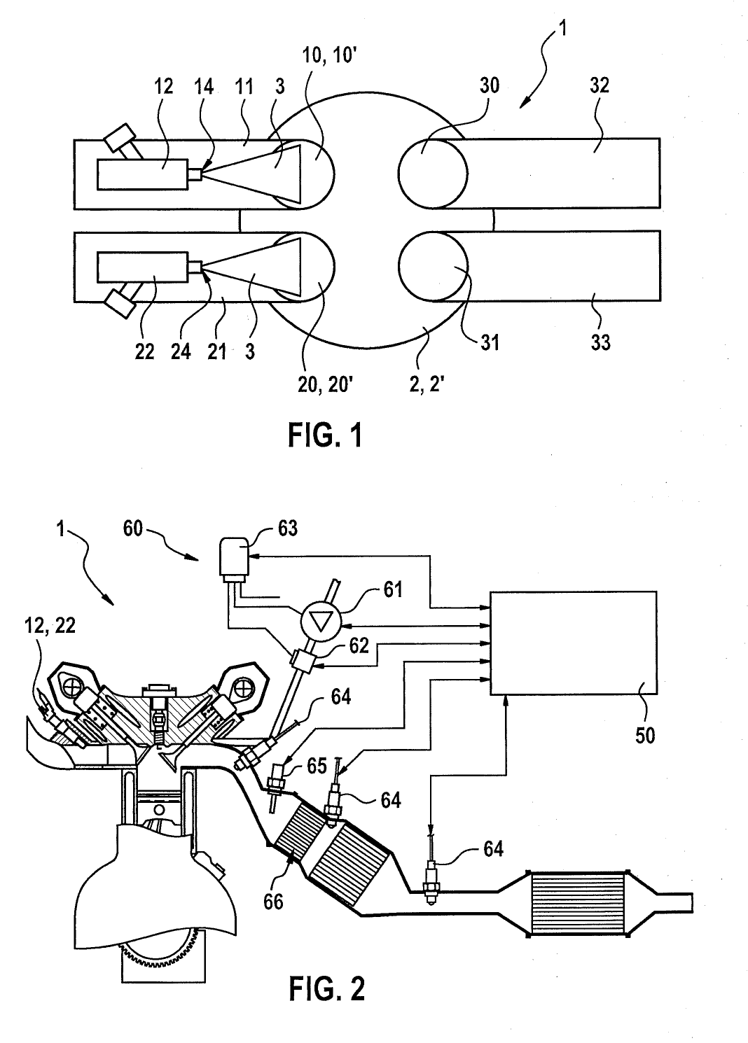

FIG. 1 shows a schematic top view of a cylinder head area of a cylinder of an internal combustion engine 1 having an injection system of the present invention. Internal combustion engine 1 has a cylinder which includes a combustion chamber 2 and in which a piston 2′ moves. The wall of combustion chamber 2 has a first and a second inlet port 10′, 20′ through each of which an air/fuel mixture is taken in into combustion chamber 2 and a first and a second outlet port 30, 31 through which the untreated exhaust gases of the combusted air/fuel mixture from combustion chamber 2 are expelled into first and second outlet channels 32, 33. Internal combustion engine 1 has a first inlet valve 10 which is provided for closing off first inlet port 10′ and is situated between a first intake channel 11 and combustion chamber 2. Internal combustion engine 1 furthermore has a second inlet valve 20 which is provided for closing off second inlet port 20′ and is situated between a second intake channel 21 and combustion chamber 2. First and second intake channels 11, 21 empty into a shared intake manifold (not illustrated) on a side facing away from combustion chamber 2, fresh air being taken in by a throttle valve (not illustrated), which is situated in the intake manifold, through the intake manifold in the direction of combustion chamber 2. In first intake channel 11, a first injector 12 is situated which has a first injection opening 14 through which fuel 3 (in particular in the form of a spray jet of fuel droplets) is sprayed through first intake channel 11 into the area of first inlet port 10′. Similarly, in second intake channel 21, a separate second injector 22 is situated which has a single second injection opening 24 through which a fuel mixture 3 is sprayed through second intake channel 21 into the area of second inlet port 20′. Internal combustion engine 1 also has a spark plug or even a plurality of spark plugs which are, however, not specifically illustrated.

In FIG. 2, a schematic illustration of a heating device 60 is illustrated for heating a catalytic converter unit 66 more rapidly for an internal combustion engine 1 according to the present invention. According to the present invention, heating device 60, in particular, has a secondary air pump 61, a secondary air valve 62, a switching relay 63 for the secondary air, a lambda sensor 64 or a plurality of lambda sensors 64, and a temperature sensor 65. Heating device 60 is controlled by a control unit 50 (engine control unit) of internal combustion engine 1 which is indicated with the aid of different double arrows in FIG. 2. When activated, secondary air pump 61 blows fresh air into the exhaust gas system via secondary air valve 62. Temperature sensor 65 transmits a signal to control unit 50 concerning the temperature of the exhaust gas and/or the catalytic converter. The illustrated system is suitable, for example, for chemically heating catalytic converter unit 66 through oxidation of exhaust gas components, e.g., of the still uncombusted exhaust gas components or also of the exhaust gas components CO to CO₂. Catalytic converter unit 66 is, in particular, provided as a three-way-catalytic converter 66. The large quantity of heat energy which is set free during this oxidation heats catalytic converter unit 66. The oxidation of CO to CO₂ is achieved in this system in that CO in the exhaust gas is generated by operating the internal combustion engine using a fuel-rich mixture and in that the oxygen needed for the oxidation of CO is blown into the exhaust gas system by secondary air pump 61.

1-12. (canceled)

13. An injection system for an internal combustion engine having at least one combustion chamber having a first inlet port and a second inlet port provided on a wall of the combustion chamber, wherein the first inlet port is closable by a first inlet valve and the second inlet port is closable by a second inlet valve, the injection system comprising:
a first injector configured to provide metered injection of fuel into the area of the first inlet port;
a second injector configured to provide metered injection of fuel into the area of the second inlet port;
a catalytic converter unit; and
a heating device configured to rapidly heat the catalytic converter unit.

14. The injection system as recited in claim 13, wherein the heating device includes a secondary air pump.

15. The injection system as recited in claim 14, wherein the secondary air pump is configured to deliver air into the combustion chamber of the internal combustion engine.

16. The injection system as recited in claim 15, wherein the first and second injectors are intake manifold injectors.

17. The injection system as recited in claim 15, wherein the first and second injectors each have only one injection opening.

18. A method for providing fuel injection for an internal combustion engine having at least one combustion chamber having a first inlet port and a second inlet port provided on a wall of the combustion chamber, wherein the first inlet port is closable by a first inlet valve and the second inlet port is closable by a second inlet valve, wherein the engine is operated in at least two different operating modes including a start operating mode and a continuous operating mode, the method comprising:
providing an injection system having:
a first injector configured to provide metered injection of fuel into the area of the first inlet port;
a second injector configured to provide metered injection of fuel into the area of the second inlet port;
a catalytic converter unit; and
a heating device configured to rapidly heat the catalytic converter unit; and
in the start operating mode, providing a shift of an ignition timing in such a way that a later ignition timing of a fuel/air mixture in the combustion chamber is implemented compared to the continuous operating mode.

19. The method as recited in claim 18, wherein the shift of the ignition timing takes place at a temperature of the catalytic converter unit which is below a predefined limiting temperature.

20. The method as recited in claim 19, wherein:
in the start operating mode, a larger fuel quantity is injected compared to a comparable operating situation of the continuous operating mode, and the heating device is activated.

21. A non-transitory computer-readable data storage medium storing a computer program having program codes which, when executed on a computer, performs a method for operating an injection system for an internal combustion engine having at least one combustion chamber having a first inlet port and a second inlet port provided on a wall of the combustion chamber, wherein the first inlet port is closable by a first inlet valve and the second inlet port is closable by a second inlet valve, the injection system having a first injector configured to provide metered injection of fuel into the area of the first inlet port; a second injector configured to provide metered injection of fuel into the area of the second inlet port; a catalytic converter unit; and a heating device configured to rapidly heat the catalytic converter unit, wherein the engine is operated in at least two different operating modes including a start operating mode and a continuous operating mode, the method comprising:
in the start operating mode, providing a shift of an ignition timing in such a way that a later ignition timing of a fuel/air mixture in the combustion chamber is implemented compared to the continuous operating mode;
wherein the shift of the ignition timing takes place at a temperature of the catalytic converter unit which is below a predefined limiting temperature.
